(19) United States
(12) Patent Application Publication
(10) Pub. No.: US 2025/0121978 A1
(43) Pub. Date: Apr. 17, 2025

(54) Container With Liner

(71) Applicant: Graphic Packaging International, LLC, Atlanta, GA (US)

(72) Inventor: Lee Nowak, Leicestershire (GB)

(21) Appl. No.: 18/912,820

(22) Filed: Oct. 11, 2024

Related U.S. Application Data
(60) Provisional application No. 63/543,560, filed on Oct. 11, 2023.

(51) Int. Cl. B65D 5/32; B31B 50/26; B31B 105/00; B31B 110/10; B31B 120/20; B65D 5/20; B65D 5/44; B65D 5/56

(52) U.S. Cl. CPC B65D 5/321; B31B 50/26; B65D 5/2033; B65D 5/2047; B65D 5/44; B65D 5/56; B31B 2105/00; B31B 2110/10; B31B 2120/20

(57) ABSTRACT

A container for holding one or more articles. The container can comprise at least a bottom wall and a sidewall extending along an interior of the container, a flange extending outwardly from the sidewall, and a storage feature extending from the flange and spaced apart from the sidewall. The storage feature can be for at least partially holding one or more items.

### CROSS-REFERENCED TO RELATED APPLICATIONS

This application claims the benefit of U.S. Provisional Patent Application No. 63/543,560, filed on Oct. 11, 2023.

### INCORPORATION BY REFERENCE

The disclosures of U.S. Provisional Patent Application No. 63/543,560, filed on Oct. 11, 2023, U.S. patent application Ser. No. 18/805,998, filed Aug. 15, 2024, U.S. Provisional Patent Application No. 63/533,393, filed Aug. 18, 2023, U.S. patent application Ser. No. 16/037,425, filed Jul. 17, 2018, U.S. patent application Ser. No. 15/654,814, filed Jul. 20, 2017, and U.S. patent application Ser. No. 12/992,131, filed Feb. 11, 2011, are hereby incorporated by reference for all purposes as if presented herein in their entirety.

### BACKGROUND OF THE DISCLOSURE

The present disclosure relates to blanks, containers, trays, constructs, and various features and methods for forming a container from a blank. More specifically, the disclosure is generally directed to a container having a liner.

### SUMMARY OF THE DISCLOSURE

In general, one aspect of the disclosure is generally directed to a container for holding one or more products. The container can comprise at least a bottom wall and a sidewall extending along an interior of the container, a flange extending outwardly from the sidewall, and a storage feature extending from the flange and spaced apart from the sidewall. The storage feature can be for at least partially holding one or more items.

In another aspect, the disclosure is generally directed to a blank for forming a container for holding one or more products. The blank can comprise a top panel for at least partially forming a flange when the container is formed from the blank and a plurality of side flaps foldably connected to the top panel along an opening in the top panel. The plurality of side flaps can be for at least partially forming a sidewall of the container formed from the blank, and the flange can extend outwardly from the sidewall when the container is formed from the blank. A storage feature can extend from the top panel and can be spaced apart from the opening in the top panel, and the storage feature can be for at least partially holding one or more items when the container is formed from the blank.

In another aspect, the disclosure is generally directed to a method of forming a container. The method can comprise obtaining a blank comprising a top panel, a plurality of side flaps foldably connected to the top panel along an opening in the top panel, and a storage feature extending from the top panel and spaced apart from the opening in the top panel. The method further can comprise forming a sidewall at least by folding the plurality of side flaps downwardly with respect to the top panel. The top panel can at least partially form a flange extending outwardly from the sidewall. The storage feature can be for at least partially holding one or more items.

In another aspect, the disclosure is generally directed to a container for holding one or more products. The container can comprise a flange and a first sidewall extending along at least a portion of the flange. The first sidewall can extend at least partially around a first interior space of the container. A second sidewall can extend along at least a portion of the flange, and the second sidewall can extend at least partially around a second interior space of the container. A fold line can extend in the flange between the first interior space and the second interior space, and the fold line can be for folding the container at the flange to pivot the second sidewall with respect to the first sidewall.

In another aspect, the disclosure is generally directed to, in combination, a crown blank, a first bottom blank, and a second bottom blank for at least partially forming a container for holding one or more products. The crown blank can comprise at least a top panel for at least partially forming a flange of the container formed from the crown blank, the first bottom blank, and the second bottom blank. The first bottom blank can comprise a plurality of first side panels for at least partially forming a first sidewall extending along at least a portion of the flange when the container is formed from the crown blank, the first bottom blank, and the second bottom blank. The second bottom blank can comprise a plurality of second side panels for at least partially forming a second sidewall extending along at least a portion of the flange when the container is formed from the crown blank, the first bottom blank, and the second bottom blank. A fold line can extend in the top panel between the first sidewall and the sidewall when the container is formed from the crown blank, the first bottom blank, and the second bottom blank.

In another aspect, the disclosure is generally directed to a method of forming a container for holding one or more articles. The method can comprise obtaining a crown blank comprising at least a top panel and a fold line extending in the top panel, a first bottom blank comprising a plurality of first side panels, and a second bottom blank comprising a plurality of second side panels. The method further can comprise forming a first bottom component by folding the plurality of first side panels of the first bottom blank to at least partially form a first sidewall extending along at least a portion of a first interior space of the container. The method can comprise forming a second bottom component by folding the plurality of second side panels of the second bottom blank to at least partially form a second sidewall extending along at least a portion of a second interior space of the container. The method also can comprise arranging the crown blank relative to the first bottom component and the second bottom component to at least partially form a flange comprising the top panel. The first sidewall and the second sidewall cam extend along respective portions of the flange, and the fold line can extend in the top panel between the first interior space and the second interior space.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIGS. 1 and 2 are plan views of a respective first bottom blank and second bottom blank used for forming bottom components of a container according to exemplary embodiments of the disclosure.

FIG. 3 is a plan view of a top blank used for forming a crown component of the container according to exemplary embodiments of the disclosure.

FIG. 4 is a perspective top view of the container formed from the blanks of FIGS. 1-3 according to exemplary embodiments of the disclosure.

FIG. 5 is a perspective bottom view of the container of FIG. 4.

FIG. 6 is a perspective view of the container of FIGS. 4 and 5 in a pouring configuration according to exemplary embodiments of the disclosure.

FIG. 7 is a plan view of a top blank used for forming a container according to further exemplary embodiments of the disclosure.

FIG. 8 is a perspective view of the container formed from the blanks of FIGS. 1, 2, and 7 according to exemplary embodiments of the disclosure.

FIG. 9 is a perspective view of the container of FIG. 8 in a pouring configuration according to exemplary embodiments of the disclosure.

FIG. 10 is a plan view of a top blank used for forming a container according to further exemplary embodiments of the disclosure.

FIGS. 11 and 12 are perspective views of the container formed from the blanks of FIGS. 1, 2, and 10 according to exemplary embodiments of the disclosure.

FIG. 13 is a plan view of a top blank used for forming a container according to further exemplary embodiments of the disclosure.

FIGS. 14-16 are perspective views of the container formed from the blanks of FIGS. 1, 2, and 13 according to exemplary embodiments of the disclosure.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles or products. However, in other embodiments, the container or tray can be used to form other non-food containing articles or may be used for heating or cooking. In this specification, the terms “inner,” “interior,” “outer,” “exterior,” “lower,” “bottom,” “upper,” and “top” indicate orientations determined in relation to fully erected and upright packages. As described herein, constructs can be formed from blanks with multiple panels, portions, tabs, and/or flaps, which may be designated herein in terms relative to one another, e.g., “first”, “second”, “third”, etc., in sequential or nonsequential reference, without departing from the disclosure.

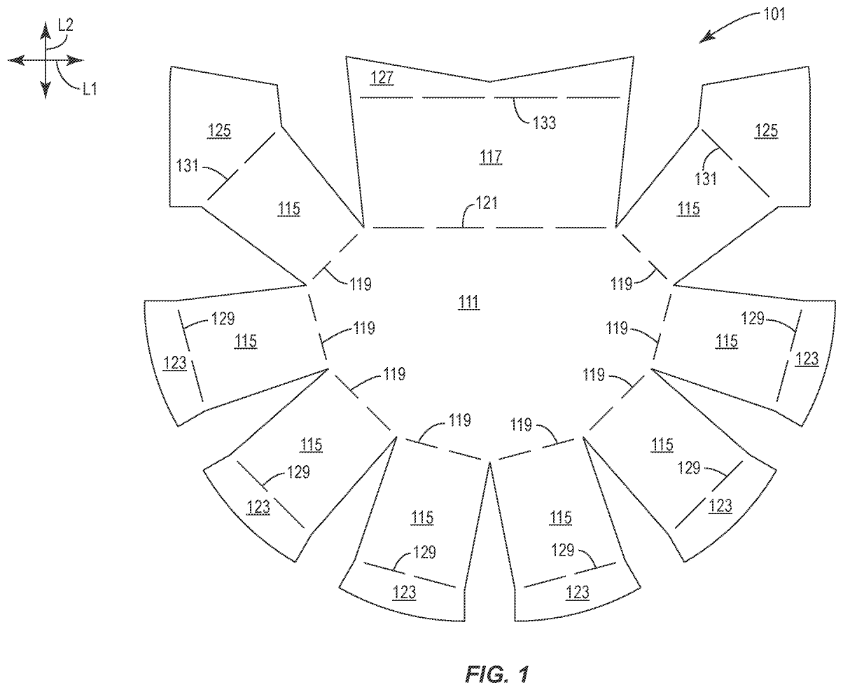

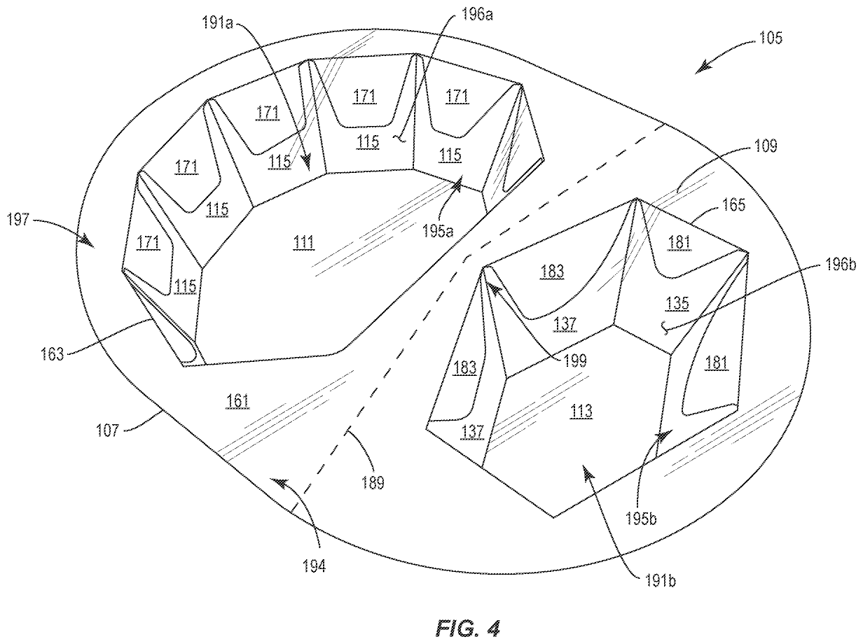

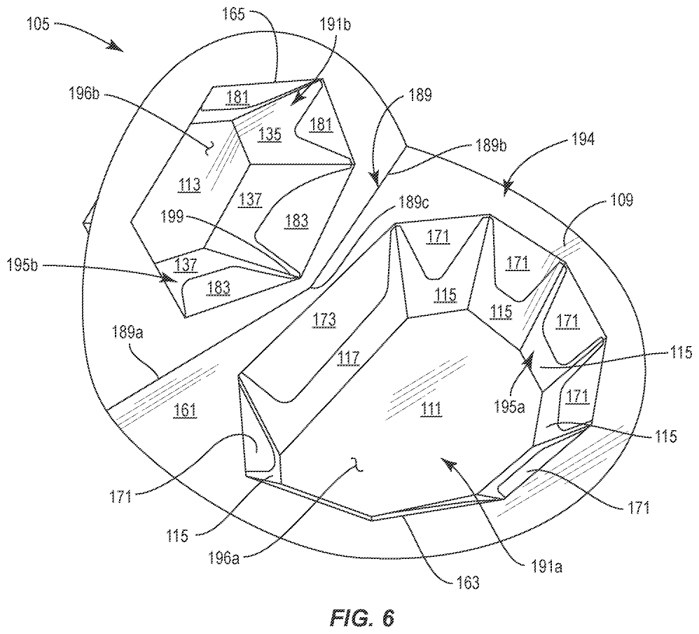

FIGS. 1-3 illustrate a first bottom blank 101, a second bottom blank 103, and a top or crown blank 104, respectively, that are used to form a container 105 (FIGS. 4-6) having a base layer 107 and a liner 109 (FIGS. 4 and 6) according to embodiments of the disclosure. In exemplary embodiments, the blanks 101, 103, 104 and the base layer 107 formed therefrom comprise paperboard (e.g., solid bleached sulphate folding boxboard), or other suitable material that can be recyclable, and the liner comprises a plastic layer such as polyethylene, PET material, or any other thermoplastic material, or a bioplastic, such as vegetable oil or starch-based plastics. The container 105 can be suitable for holding and/or displaying one or more articles (e.g., food products and/or other suitable products) for sale, transportation, storage, etc. and/or for dispensing, mixing, and/or consuming products. In some embodiments, the container 105 can be for heating a food product in an oven such as a convection or conventional heating oven or microwave oven. In an exemplary embodiment, the container 105 can be configured for holding one or more food items (not shown), such as a first food item (e.g., cercal) and a second food item (e.g., milk), in respective receiving spaces so that the food items can be combined (e.g., the milk can be poured into the cereal) after opening the package and prior to consumption of the food items. In the illustrated embodiment, the liner can be adhered, heat sealed, and/or otherwise attached to the base layer 107 and can be in contact with the food product(s) and/or other products held in the container 105. In some embodiments, the base layer 107 and the liner 109 can be separated after use of the package to allow both the base layer 107 and the liner 109 to be placed in separate waste streams (e.g., for recycling, composting, incineration, land fill, etc.).

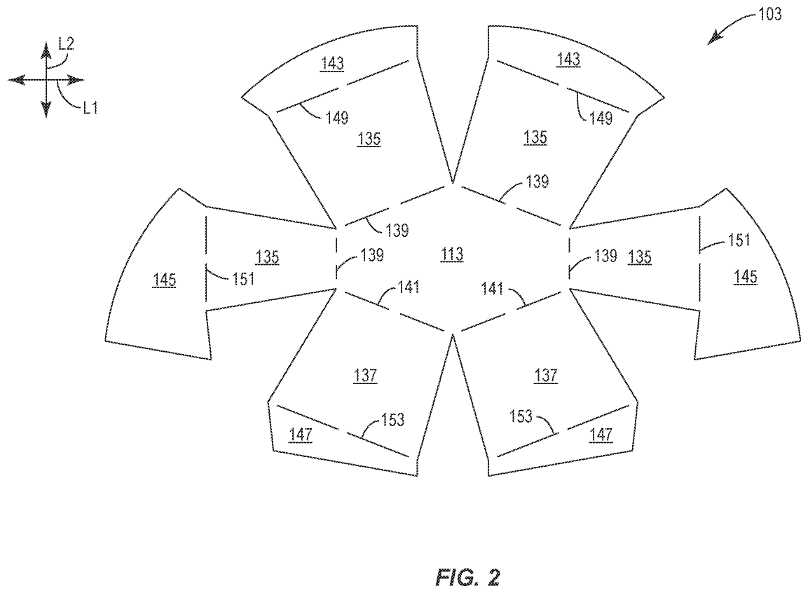

As shown in FIGS. 1 and 2, each of the bottom blanks 101, 103 has a longitudinal direction L1 and a lateral direction L2. In the illustrated embodiments, the bottom blanks 101, 103 can have a respective first bottom panel 111 and second bottom panel 113. As shown in FIG. 1, the first bottom blank 101 can include a plurality of first side panels, including first outer side panels 115 and a first inner or central side panel 117. In embodiments, each of the outer side panels 115 can be foldably connected to the first bottom panel 111 along a respective fold line 119 (e.g., oblique fold lines), and the inner side panel 117 can be foldably connected to the first bottom panel 111 along a longitudinal fold line 121. As shown in FIG. 1, the first bottom blank 101 can include a plurality of first flange portions or attachment flaps, including first outer flange portions 123, first corner flange portions 125, and a first inner or central flange portion 127. In embodiments, each of the outer flange portions 123 can be foldably connected to respective outer side panels 115 along respective fold lines 129 (e.g., oblique fold lines), each of the corner flange portions 125 can be foldably connected to the respective outer side panels 115 that are adjacent the inner side panel 117 along respective fold lines 131 (e.g., oblique fold lines), and the inner flange portion 127 can be foldably connected to the inner side panel 117 along a longitudinal fold line 133. As shown in FIG. 1, each of the flange portions 123, 125, 127 can have a respective shape corresponding to respective portions of the top blank 104, as described in more detail below.

As shown in FIG. 2, the second bottom blank 103 can include a plurality of second side panels, including second outer side panels 135 and second inner or central side panels 137. In embodiments, each of the outer side panels 135 can be foldably connected to the second bottom panel 113 along a respective fold line 139 (e.g., oblique fold lines and/or lateral fold lines), and the inner side panels 137 can be foldably connected to the second bottom panel 113 along respective fold lines 141 (e.g., oblique fold lines). As shown in FIG. 2, the second bottom blank 103 can include a plurality of second flange portions or attachment flaps, including second outer flange portions 143, second corner flange portions 145, and inner or central flange portions 147. In embodiments, each of the outer flange portions 143 can be foldably connected to respective outer side panels 135 along respective fold lines 149 (e.g., oblique fold lines), each of the corner flange portions 145 can be foldably connected to the respective outer side panels 135 that are adjacent the respective inner side panel 137 along respective fold lines 151 (e.g., lateral fold lines), and the inner flange portions 147 can be foldably connected to the respective inner side panels 137 along respective fold lines 153 (e.g., oblique fold lines). As shown in FIG. 2, each of the flange portions 143, 145, 147 can have a respective shape corresponding to respective portions of the top blank 104, as described in more detail below.

The bottom blanks 101, 103 could be otherwise shaped, arranged, and/or configured without departing from the disclosure. In addition, any of the bottom panels 111, 113, the first side panels 115, 117, the first flange portions 123, 125, 127, the second side panels 135, 137, and/or the second flange portions 143, 145, 147 could be omitted or could be otherwise shaped, arranged, positioned, and/or configured without departing from the disclosure. For example, either of the bottom blanks 101, 103 could have any suitable number of panels and any suitable shape for the perimeter around the bottom panels 111, 113.

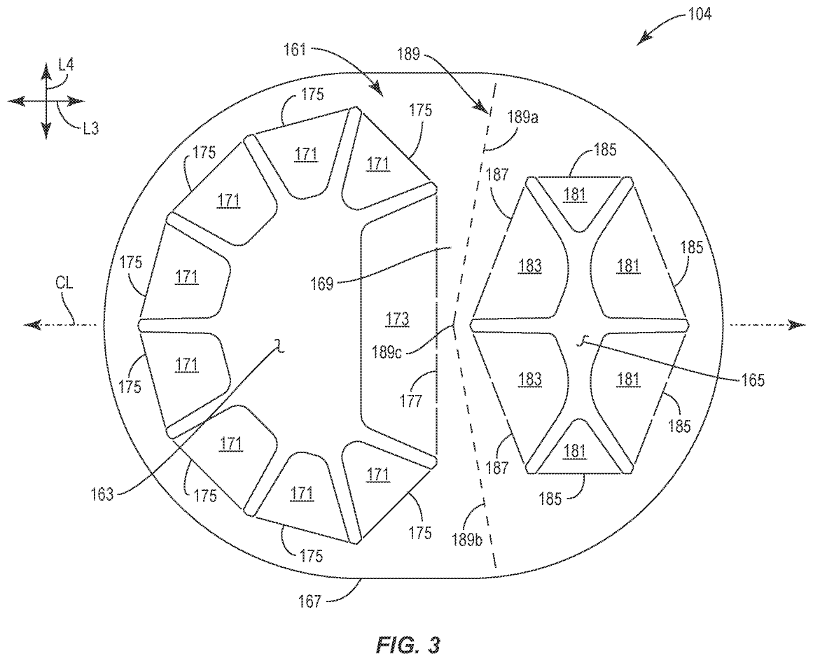

As shown in FIG. 3, the top blank 104 has a longitudinal direction L3 and a lateral direction L4 and includes a main panel or top panel 161 at least partially defining a first opening 163 and a second opening 165. In embodiments, the openings 163, 165 can be spaced inwardly from the outer perimeter 167 of the top blank 104 and can be spaced apart from one another by a central portion 169 of the top panel 161. In the illustrated embodiments, the top blank 104 can include a plurality of first side flaps foldably connected to the top panel 161 along the first opening 163 and a plurality of second side flaps foldably connected to the top panel 161 along the second opening 165. As shown in FIG. 3, the plurality of first side flaps can include first outer side flaps 171 and a first inner or central side flap 173, wherein the outer side flaps 171 are foldably connected to the top panel 161 along respective fold lines 175 (e.g., oblique fold lines) and the inner side flap 173 is foldably connected to the top panel 161 along a lateral fold line 177. In the illustrated embodiments, the plurality of second side flaps can include second outer side flaps 181 and second inner or central side flaps 183, wherein the outer side flaps 181 are foldably connected to the top panel 161 along respective fold lines 185 (e.g., oblique and/or longitudinal fold lines) and the inner side flaps 183 are foldably connected to the top panel 161 along respective fold lines 187 (e.g., oblique fold lines).

As shown in FIG. 3, the top panel 161 can include a fold 189 (e.g., a central fold line) extending from the perimeter 167 on one side of the top blank 104 to the perimeter 167 on the opposing side of the top blank 104 through the central portion 169 of the top panel 161 (e.g., extending between and spaced apart from the openings 163, 165). In embodiments, the fold 189 can be a V-shaped fold line and can include two oblique portions 189a, 189b extending from a vertex 189c so that the fold 189 is convex with respect to the first opening 163 and concave with respect to the second opening 165. In the illustrated embodiments, the openings 163, 165 and the vertex 189c can be centered on a longitudinal centerline CL.

The top blank 104 could be otherwise shaped, arranged, and/or configured without departing from the disclosure. In addition, any of the top panel 161, the first side flaps 171, 173, and/or the second side flaps 181, 183 could be omitted or could be otherwise shaped, arranged, positioned, and/or configured without departing from the disclosure. For example, the top blank 104 could have any suitable number of panels and any suitable shape for the outer perimeter 167 and/or for the openings 163, 165.

When the container 105 is formed from the bottom blanks 101, 103 and the top blank 104 (e.g., manually or by a forming tool, not shown), the first side panels 115, 117 of the first bottom blank 101 can be folded upwardly relative to the first bottom panel 111 along the respective fold lines 119, 121 to form a first bottom construct or component 191a and the second side panels 135, 137 of the second bottom blank 103 can be folded upwardly relative to the second bottom panel 113 along the respective fold lines 139, 141 to form a second bottom construct or component 191b. In embodiments, the respectively adjacent edges of the first side panels 115, 117 can be positioned to be adjacent and/or to abut one another when the first side panels 115, 117 are folded upwardly into position, and the respectively adjacent edges of the second side panels 135, 137 can be positioned to be adjacent and/or to abut one another when the second side panels 135, 137 are folded upwardly into position.

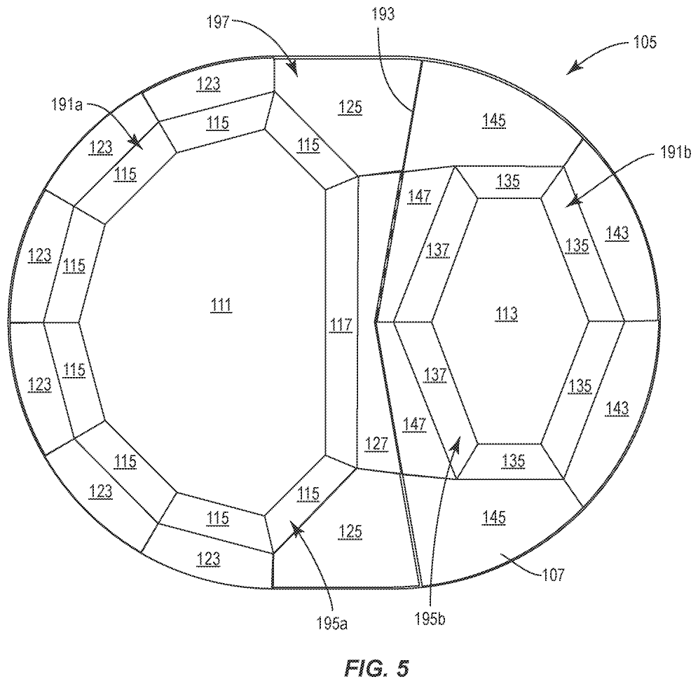

In the illustrated embodiments, the bottom constructs 191a, 191b further can be formed by folding the first flange portions 123, 125 and the second flange portions 143, 145 outwardly relative to the respective first side panels 115, 117 and second side panels 135, 137 along the respective fold lines 129, 133, 149, 153. In embodiments, the first flange portions 125, 127 can be shaped to fit together, such as wherein the respectively adjacent edges of the first flange portions 125, 127 are adjacent and/or abut one another (e.g., as shown in FIG. 5). Similarly, the second flange portions 135, 137 can be shaped to fit together, such as wherein the respectively adjacent edges of the second flange portions 145, 147 are adjacent and/or abut one another (e.g., as shown in FIG. 5). Further, the first corner flange portions 125, the first inner flange portion 127, the second corner flange portions 145, and the second inner flange portions 147 can be shaped so that the first corner flange portions 125 and the first inner flange portion 127 fit together with (e.g., are adjacent and/or abut) the respective second corner flange portions 145 and the second inner flange portions 147 (e.g., along a line 193, FIG. 5) when the first bottom construct 191a and the second bottom construct 191b are arranged relative to one another for attachment to the top blank 104. The bottom constructs 191a, 191b could be otherwise formed without departing from the disclosure.

The container 105 further can be formed by forming the top blank 104 into a top or crown component 194 placing the top panel 161 of the top blank 104 over the flange portions 123, 125, 127, 143, 145, 147 when the bottom constructs 191a, 191b are arranged to be adjacent one another and/or to abut along the line 193. In the illustrated embodiments, the top panel 161 can be in an overlapping relationship with the flange portions 123, 125, 127, 143, 145, 147 (e.g., so that the flange portions are in face-to-face contact with the bottom surface of the top panel 161). In embodiments, line 193 between the bottom constructs 191a, 191b can extend along and/or be aligned with the fold 189 in the top panel 161. As shown in FIG. 5, the first outer flange portions 123, the second outer flange portions 143, and the second corner flange portion 145 can have curved edges that extend along at least a portion of the outer edge or perimeter 167 of the top panel 161, and the first corner flange portions 125 can have straight edges that extend along at least a portion of the perimeter 167 of the top panel 161 that extends in the longitudinal direction L3. Further, each of the first corner flange portions 125, the first inner flange portion 127, the second corner flange portions 145, and the second inner flange portions 147 can have oblique edges that extend along portions of the fold 189 in the top panel 161. Accordingly, the flange portions 123, 125, 127, 143, 145, 147 can be shaped to fit together and to fit along portions of the top panel 161 (e.g., as shown in FIG. 5).

As shown in FIGS. 4 and 6, the first side flaps 171, 173 can be downwardly folded along the respective fold lines 175, 177 through the first opening 163 in the top panel 161 so that the first side flaps 171, 173 of the crown component 194 formed from the top blank 104 overlap the respective first side panels 115, 117 of the first bottom construct 191a. In embodiments, the first side flaps 171, 173 and the first side panels 115, 117 can cooperate to form a first sidewall 195a of the container 105. Similarly, the second side flaps 181, 183 can be downwardly folded along the respective fold lines 185, 187 through the second opening 165 in the top panel 161 so that the second side flaps 181, 183 of the crown component 194 formed from the top blank 104 overlap the respective second side panels 135, 137 of the second bottom construct 191b. As shown in FIGS. 4-6, the second side flaps 181, 183 and the second side panels 135, 137 can cooperate to form a second sidewall 195b of the container 105. In embodiments, the first sidewall 195a and the first bottom panel 111 can extend along and at least partially define a first interior or receiving space 196a of the container 105 extending from the first opening 163 in the top panel 161. Similarly, the second sidewall 195b and the second bottom panel 113 can extend along and at least partially define a second interior or receiving space 196b of the container 105 extending from the second opening 165 in the top panel 161.

In the illustrated embodiments, the flange portions 123, 125, 127, 143, 145, 147 can help reinforce the top panel 161 and can cooperate with the top panel 161 to at least partially form a flange 197 of the container 105, with the top panel 161 providing a smooth, continuous upper surface of the flange 197 around the openings 163, 165 in the top panel 161. In embodiments, some or all of the side flaps 171, 173, 181, 183 can be attached (e.g., adhered) to the respective side panels 115, 117, 135, 137 and/or some or all of the flange portions 123, 125, 127, 143, 145, 147 can be attached (e.g., adhered) to the underside of the top panel 161. Alternatively, the side flaps 71, 173, 181, 183 and the side panels 115, 117, 135, 137 can remain unattached in an overlapping relationship and/or the flange portions 123, 125, 127, 143, 145, 147 and the top panel 161 can remain unattached in an overlapping relationship. The crown component 194 formed from the top blank 104 could be otherwise assembled with the bottom constructs 191a, 191b without departing from the disclosure.

In embodiments, a liner material (not shown) can be applied over at least the top panel 161, the sidewalls 195a, 195b, and the bottom panels 111, 113 so that the liner material can form a liner 109 adhered to at least the overlapped flaps and panels of the sidewalls 195a, 195b and to the bottom panels 111, 113 along the respective receiving spaces 196a, 196b of the container 105. In embodiments, the liner 109 further can be attached along at least a portion of the top panel 161. In exemplary embodiments, the liner 109 can be adhered to the base layer 107 (e.g., the top blank 104 and the bottom constructs 191a, 191b) by a heat seal layer, adhesive, and/or other suitable features. In the illustrated embodiments, the attachment of the liner 109 to the base layer 107 can attach the side flaps 171, 173, 181, 183 to the respective side panels 115, 117, 135, 137. As shown in FIGS. 4 and 6, the side flaps 171, 173, 181, 183 are smaller than the respective side panels 115, 117, 135, 137 so that portions of each of the flaps and panels are in contact with the liner 109. In embodiments, the liner 109 can at least partially hold the portions of the base layer 107 together and maintain the shape of the container 105. Alternatively, or in addition, one or more aspects of the base layer 107 can be attached by thermo-mechanical sealing, adhesive, etc. In embodiments, a lid, film, and/or other cover can be attached to the container 105 for sealing at least the receiving spaces 196a, 196b closed.

As shown in FIGS. 4-6, the container 105 can be configured for facilitating pouring at least a portion of the contents of the second receiving space 196b into the first receiving space 196a for combining the poured contents with the contents of the first receiving space 196a. For example, the second inner side panels 137 and the second inner side flaps 183 can extend along an oblique angle with respect to one another to at least partially define a pouring spout 199 along the portion of the second sidewall 195b that is closest to the first opening 163. In the illustrated embodiment, the pour spout 199 can be aligned with the vertex 189c of the fold 189 along the longitudinal centerline CL. Accordingly, as shown in FIG. 6, a user can fold the container 105 along the fold 189 to pivot the portion of the container 105 including the second receiving space 196b upwardly about the fold 189 so that flowable material in the second receiving space 196b (e.g., milk, granola, nuts, berries, and/or other suitable food products and/or non-food products) can flow along the pour spout 199, out of the second receiving space 196b and into the first receiving space 196a (e.g., over cereal, yogurt, and/or other suitable food products and/or non-food products). The first receiving space 196a can then serve as a bowl for mixing and/or consuming the food products.

In embodiments, the side panels 115, 117, 135, 137 can extend obliquely (e.g., upwardly and outwardly) from the respective bottom panels 111, 113 and the openings 163, 165 in the top panel 161 can be larger than the respective bottom panels 111, 113 for facilitating stacking of a plurality of the containers 105. For example, the bottom constructs 191a, 191b of a container 105 can be at least partially received in the respective receiving spaces 196a, 196b of a lower container 105 in a stack (not shown). The container 105 could be otherwise formed and/or configured without departing from the disclosure.

In exemplary embodiments, one or more products (not shown) can be inserted into the receiving spaces 196a, 196b and a lidding film or other suitable covering (not shown) can be attached (e.g., sealed) to the upper surface of the flange 197 over the receiving spaces 196a, 196b, closing the openings 163, 165. For example, it may be desirable to keep products separate from one another until use (e.g., wet and dry food ingredients). These products can be kept in the separate receiving spaces until the package is opened (e.g., by removing a lidding film) and the products are mixed by a user (e.g., by pouring the contents of the second receiving space 196b into the first receiving space 196a as described above).

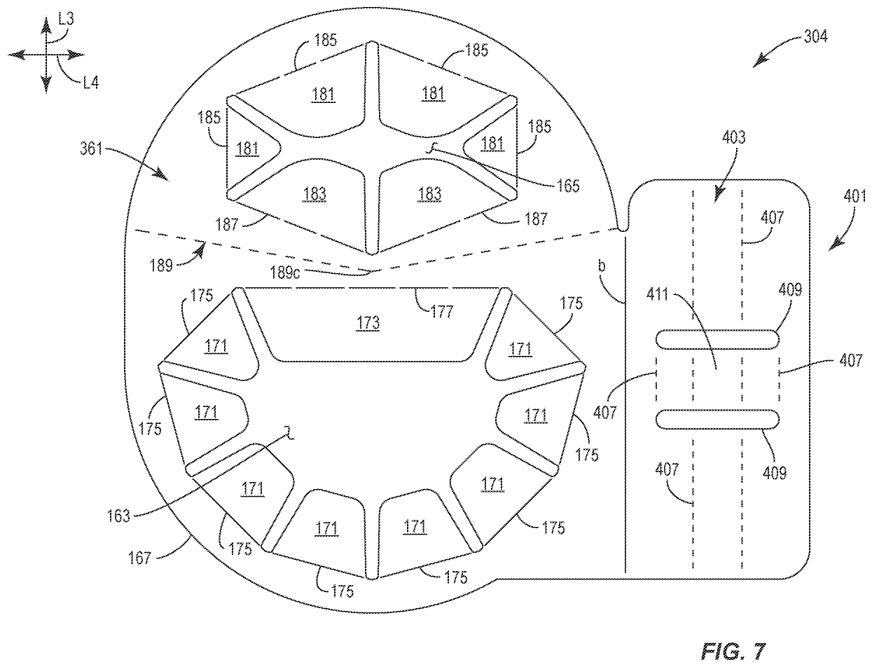

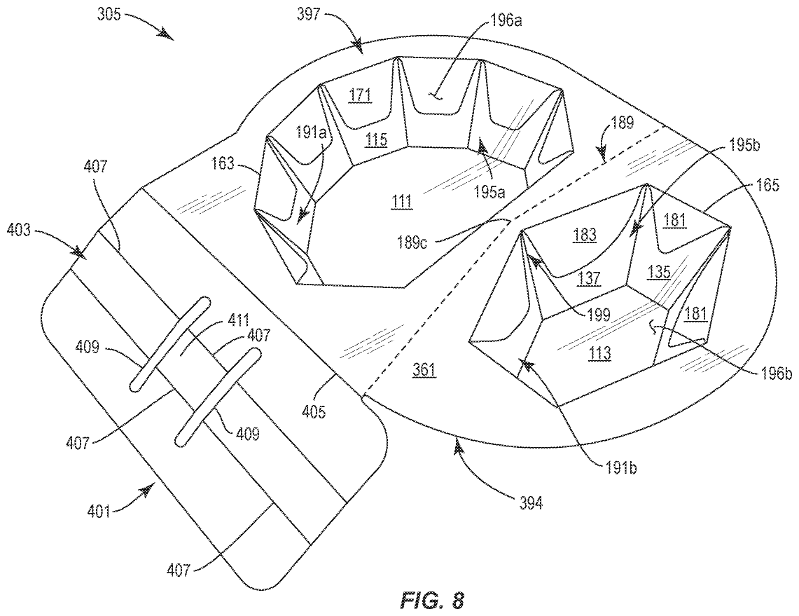

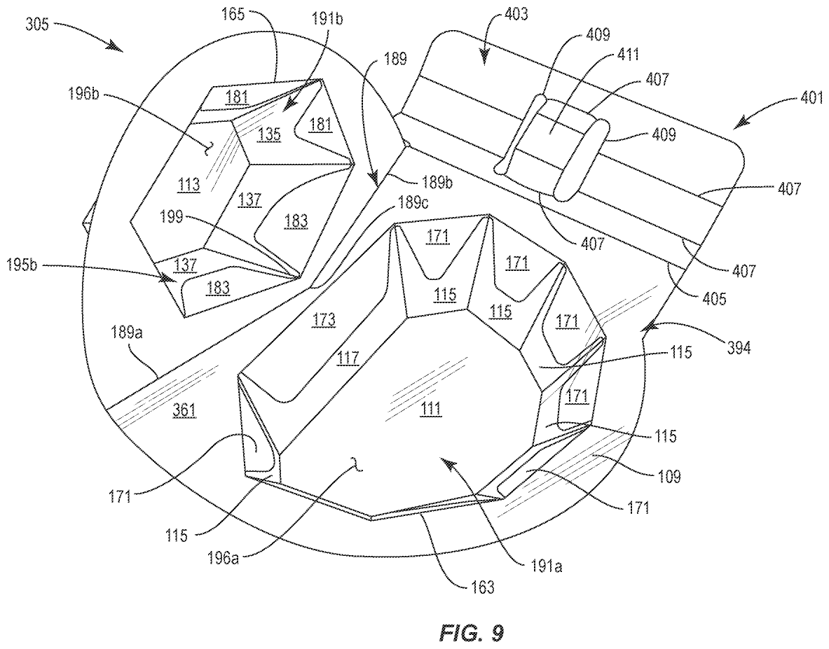

FIG. 7 is a plan view of a top or crown blank 304 for cooperating with the bottom blanks 101, 103 (FIGS. 1 and 2, respectively) to form a container 305 (FIGS. 8 and 9) of a second embodiment of the disclosure (e.g., a container including a crown or crown component 394 formed from the top blank 304 and the bottom constructs or components 191a, 191b formed from the bottom blanks 101, 103, wherein the crown and the bottom constructs can be secured together by at least a liner to form a base layer). The second embodiment is generally similar to the first embodiment, except for variations noted and variations that will be apparent to one of ordinary skill in the art. Accordingly, similar or identical features of the embodiments have been given like or similar reference numbers. As shown in FIG. 7, the top blank 304 is similar to the top blank 104 of FIG. 3 except that the top blank 304 includes a storage feature 401 extending from the top panel 361. In the illustrated embodiments, the storage feature 401 can include a storage panel 403 that is foldably connected to the top panel 361 along longitudinal fold line 405. In embodiment, the storage panel 403 can include a plurality of longitudinal fold lines 407 for facilitating bending or flexing of the storage panel 403. As shown in FIG. 7, two slots 409 can extend (e.g., in the lateral direction L4) of the storage panel 403 and can at least partially define a strap 411 in the storage panel 403. The storage feature 401 could be otherwise positioned, shaped, arranged, and/or configured without departing from the disclosure.

When the container 305 is formed (FIGS. 8 and 9), the storage panel 403 of the storage feature 401 can extend from the flange 397 of the container 305. A utensil (e.g., a spoon or other suitable utensil) and/or other suitable items (not shown) can be at least partially secured to the storage feature 401. For example, a spoon (not shown) can be engaged with the storage panel 403 by sliding a portion of the spoon through the slots 409 in the storage panel 403 so that a portion of the spoon extends under the strap 411 and at least end portions of the spoon contact a top surface of the storage panel 403. In embodiments, as shown by way of example in FIG. 9, the strap 411 can fold upwardly along the fold lines 407 and the storage panel 403 can fold downwardly relative to the strap 411 along the fold lines 407 to facilitate receiving the utensil between the strap 411 and the storage panel 403 via the slots 409. Alternatively, the spoon or other utensil or other item could be secured under the storage panel 403. In other exemplary embodiments, the container 305 can be configured to hold cosmetics and the storage feature 401 can hold a brush and/or applicator for the cosmetics, the container 305 could hold paints and the storage feature 401 can hold a brush, the container 305 could hold adhesives or components of an adhesive and the storage feature 401 can hold an applicator, etc. In further examples, the utensil or other suitable items can include sauce and/or dressing packets, flavor packets (e.g., with powdered flavorings, herbs, spices, salt, etc.), packages of additional food items (e.g., that need to be kept separate/dry), etc. The container 305 could be otherwise formed and/or configured without departing from the scope of the disclosure.

As shown in FIGS. 8 and 9, the top panel 361 of the crown component 394 can overlap the flange portions 123, 125, 127, 143, 145, 147, which can help reinforce the top panel 361 and can cooperate with the top panel 361 to at least partially form a flange 397 of the container 305. The flange 397 can be formed in a similar or identical manner as the flange 197 of the prior embodiments. Alternatively, the flange 397 could be otherwise formed without departing from the disclosure.

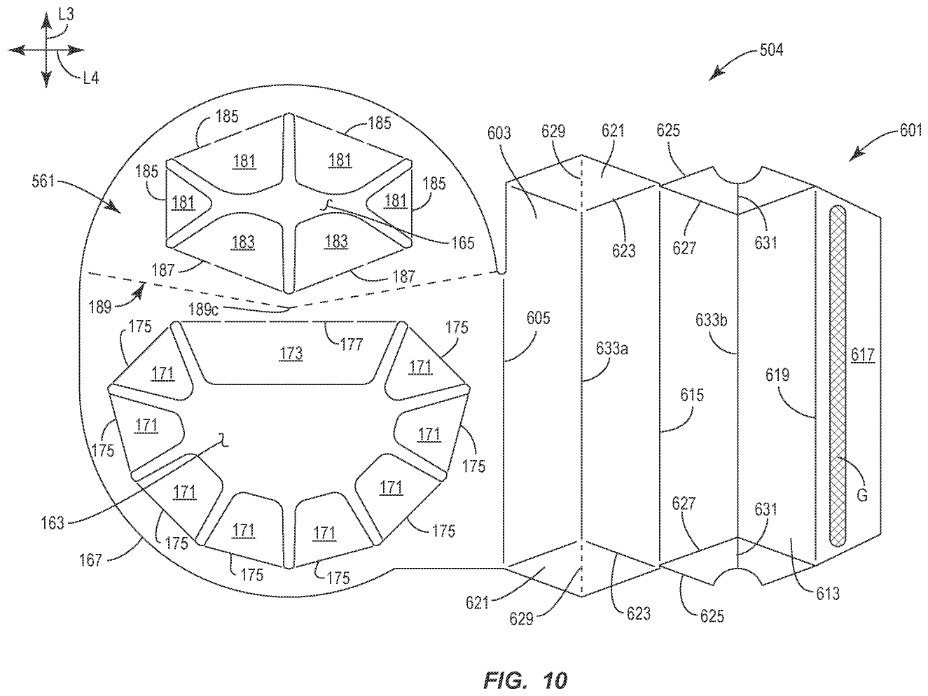

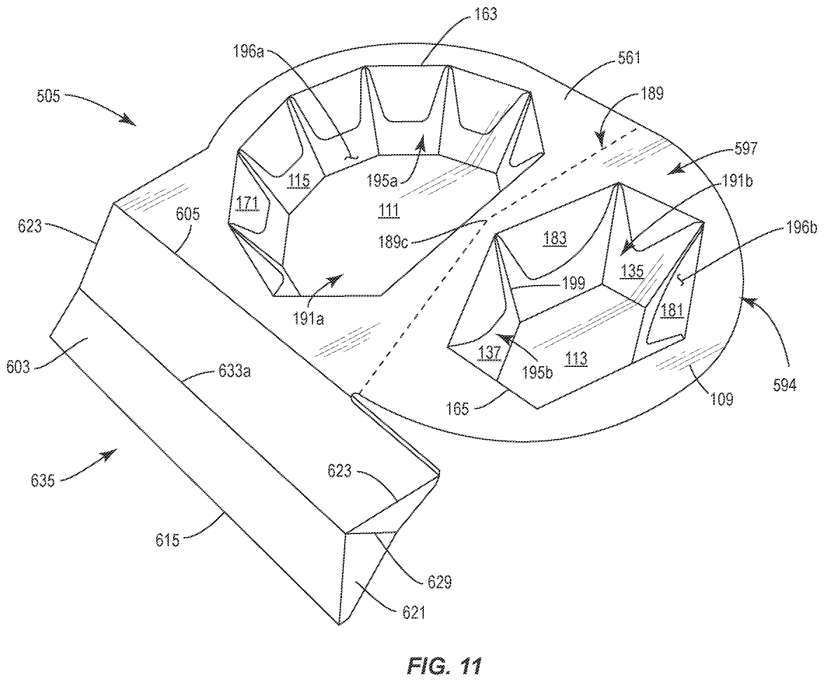

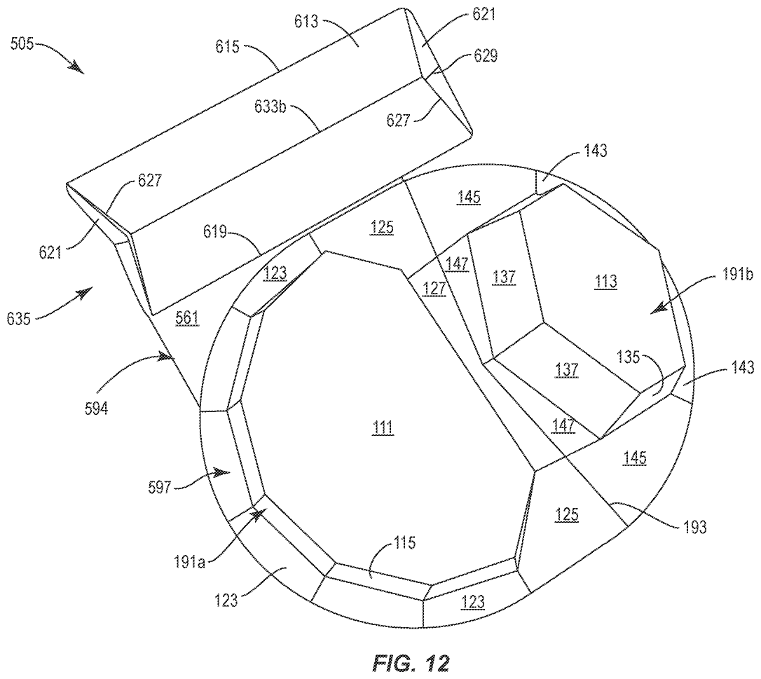

FIG. 10 is a plan view of a top or crown blank 504 for cooperating with the bottom blanks 101, 103 (FIGS. 1 and 2, respectively) to form a container 505 (FIGS. 11 and 12) of a third embodiment of the disclosure (e.g., a container including a crown or crown component 594 formed from the top blank 504 and the bottom constructs or components 191a, 191b formed from the bottom blanks 101, 103, wherein the crown and the bottom constructs can be secured together by at least a liner to form a base layer). The second embodiment is generally similar to the prior embodiments, except for variations noted and variations that will be apparent to one of ordinary skill in the art. Accordingly, similar or identical features of the embodiments have been given like or similar reference numbers. As shown in FIG. 10, the top blank 504 is similar to the top blanks 104, 304 of FIGS. 3 and 7 except that the top blank 504 includes a storage feature 601 extending from the top panel 561.

As shown in FIG. 10, the storage feature 601 can include a storage top panel 603 foldably connected to the top panel 561 along a longitudinal fold line 605 and a storage bottom panel 613 foldably connected to the storage top panel 603 along a longitudinal fold line 615. In the illustrated embodiments, an attachment flap 617 can be foldably connected to the storage bottom panel 613 along a longitudinal fold line 619, two top end flaps 621 can be foldably connected at opposite ends of the storage top panel 603 along respective oblique fold lines 623 (e.g., V-shaped fold lines), and two bottom end flaps 625 can be foldably connected at opposite ends of the storage bottom panel 613 along respective oblique fold lines 627 (e.g., V-shaped fold lines). As shown in FIG. 10, each of the top end flaps 621 can be diamond shaped with a longitudinal fold line 629 extending between two of the vertices of the diamond, and each of the bottom end flaps 625 can be partially diamond shaped with an arcuate cutout and a longitudinal fold line 631. In embodiments, a central top fold line 633a and a central bottom fold line 633b can extend in the respective storage top panel 603 and storage bottom panel 613. The storage feature 601 could be otherwise positioned, shaped, arranged, and/or configured without departing from the disclosure.

When the container 505 is formed (FIGS. 11 and 12), the storage feature 601 can be formed into a pocket 635, wherein at least the storage top panel 603 and the storage bottom panel 613 extend along a storage interior of the pocket 635. In embodiments, the pocket 635 can be formed by folding the storage bottom panel 613 and the attachment flap 617 along the longitudinal fold lines 615, 619 so that the storage bottom panel 613 extends opposite to the storage top panel 603 and the attachment flap 617 is in an overlapping relationship with at least a portion of the storage top panel 603. In the illustrated embodiments, the attachment flap 617 can be glued in face-to-face contact with the storage top panel 603 (e.g., by a glue strip G, FIG. 10, or another suitable feature). In embodiments, a utensil, flavor packet, dressing pouch, and/or other suitable item(s) (not shown) can be inserted into the interior of the pocket 635 (e.g., through one of the ends of the pocket).

In embodiments, one or both of the ends of the pocket 635 can be closed such as by folding the bottom end flaps 625 along the oblique fold lines 627 and folding the top end flaps 621 along the oblique fold lines 623 so that the end flaps extend over the respective ends of the pocket 635. When the end flaps 621, 625 are pushed inwardly at the respective ends of the pocket 635, the pocket 635 can form up and the end panels can snap into position. In embodiments, the shape of the end flaps 621, 625 and the longitudinal fold lines 629, 637 help create tension in the closed end panels so that the end panels resist folding from the closed configuration to an open configuration. The container 505 could be otherwise formed and/or configured without departing from the scope of the disclosure.

As shown in FIGS. 11 and 12, the top panel 561 of the crown component 594 can overlap the flange portions 123, 125, 127, 143, 145, 147, which can help reinforce the top panel 561 and can cooperate with the top panel 561 to at least partially form a flange 597 of the container 505. The flange 597 can be formed in a similar or identical manner as the flange 197, 397 of the prior embodiments. Alternatively, the flange 597 could be otherwise formed without departing from the disclosure.

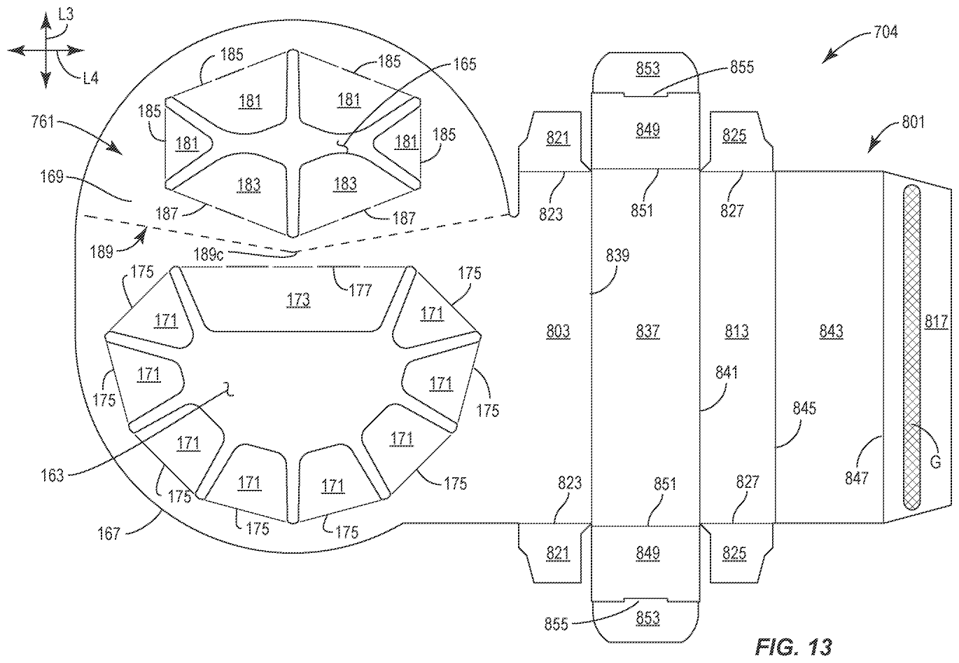

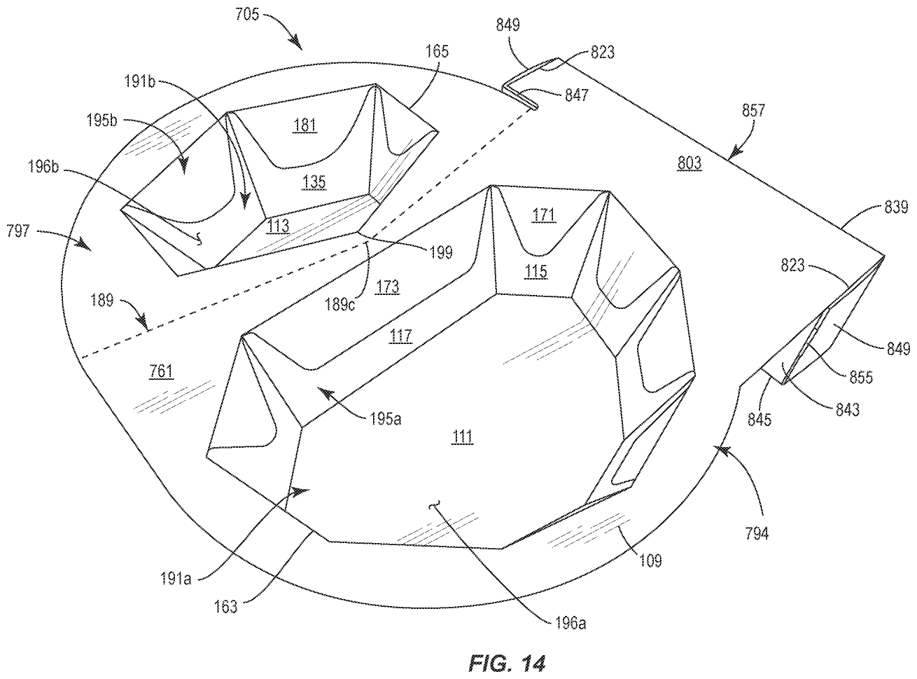

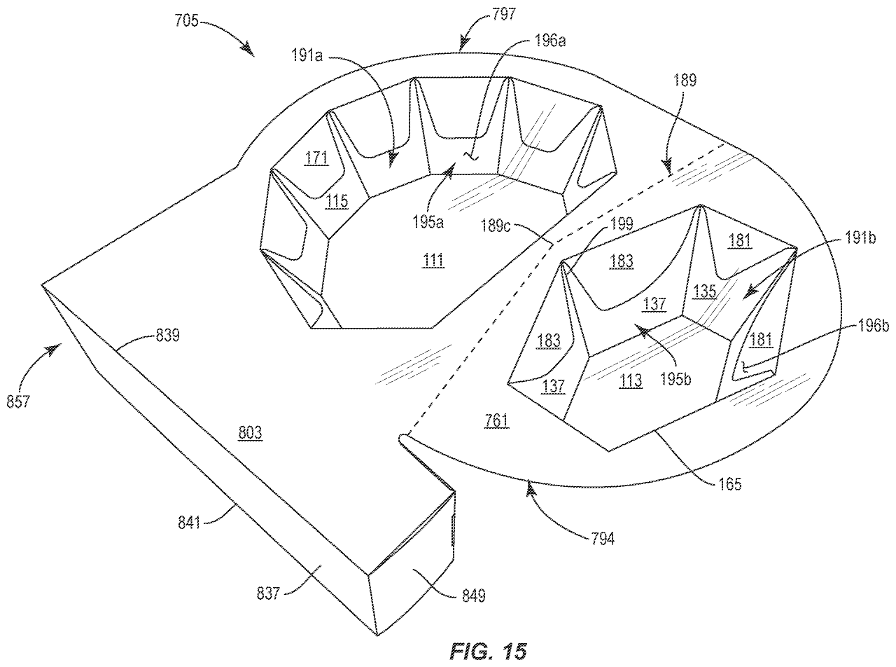

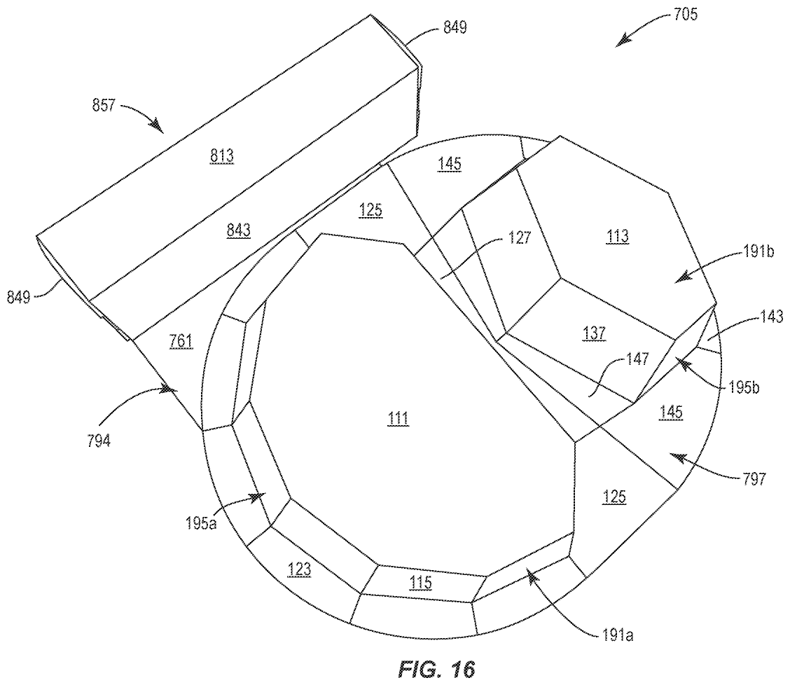

FIG. 13 is a plan view of a top or crown blank 704 for cooperating with the bottom blanks 101, 103 (FIGS. 1 and 2, respectively) to form a container 705 (FIGS. 14-16) of a fourth embodiment of the disclosure (e.g., a container including a crown or crown component 794 formed from the top blank 704 and the bottom constructs or components 191a, 191b formed from the bottom blanks 101, 103, wherein the crown and the bottom constructs can be secured together by at least a liner to form a base layer). The second embodiment is generally similar to the prior embodiments, except for variations noted and variations that will be apparent to one of ordinary skill in the art. Accordingly, similar or identical features of the embodiments have been given like or similar reference numbers. As shown in FIG. 13, the top blank 704 is similar to the top blanks 104, 304, 504 of FIGS. 3, 7, and 10 except that the top blank 704 includes a storage feature 801 extending from the top panel 761.

As shown in FIG. 13, the storage feature 801 can include storage top panel 803 extending from the top panel 761, a first storage side panel 837 foldably connected to the storage top panel 803 along a longitudinal fold line 839, a storage bottom panel 813 foldably connected to the first storage side panel 837 along a longitudinal fold line 841, a second storage side panel 843 foldably connected to the storage bottom panel 813 along a longitudinal fold line 845, and an attachment flap 817 foldably connected to the second storage side panel 843 along a longitudinal fold line 847. In the illustrated embodiments, a plurality of end flaps can be foldably connected along opposing marginal portions of the storage feature 801. In embodiments, the end flaps can include top end flaps 821 foldably connected to opposite ends of the storage top panel 803 along respective lateral fold lines 823, bottom end flaps 825 foldably connected to opposite ends of the storage bottom panel 813 along respective lateral fold lines 827, and side end flaps 849 foldably connected to opposite ends of the storage side panel 837 along respective lateral fold lines 851. In embodiments, a tuck-in tab 853 can be foldably connected to each of the side end flaps 849 along a respective lateral fold line 855. The storage feature 801 could be otherwise positioned, shaped, arranged, and/or configured without departing from the disclosure.

When the container 705 is formed (FIGS. 14-16), the storage feature 801 can be formed into a carton 857 (e.g., an integrated carton), wherein at least the storage top panel 803, the storage side panels 837, 843, and the storage bottom panel 813 extend along a storage interior of the carton 857. In embodiments, the carton 857 can be formed by folding the storage side panels 837, 843, the storage bottom panel 813, and the attachment flap 817 along the longitudinal fold lines 839, 841, 845, 847 so that the storage bottom panel 813 extends opposite to the storage top panel 803, the storage side panels 837, 843 are opposite one another, and the attachment flap 817 is in an overlapping relationship with at least a portion of the storage top panel 803. In the illustrated embodiments, the attachment flap 817 can be glued in face-to-face contact with the storage top panel 803 (e.g., by a glue strip G, FIG. 13, or another suitable feature). In embodiments, a utensil or other suitable item (not shown) can be inserted into the interior of the carton 857 (e.g., through one of the ends of the carto

In embodiments, one or both of the ends of the carton 857 can be closed such as by folding the end panels 821, 825, 849 over the respective ends of the carton 857 (e.g., so that the side end flaps 849 at least partially overlap the respective end flaps 821, 825). Either of the ends could be closed before or after one or more items is loaded into the integrated carton 857. The tabs 853 can be folded along the respective lateral fold line 855 and tucked into the carton for helping to hold the end flaps in the closed position. The container 705 could be otherwise formed and/or configured without departing from the scope of the disclosure.

As shown in FIGS. 14-16, the top panel 761 of the crown component 794 can overlap the flange portions 123, 125, 127, 143, 145, 147, which can help reinforce the top panel 761 and can cooperate with the top panel 761 to at least partially form a flange 797 of the container 705. The flange 797 can be formed in a similar or identical manner as the flange 197, 397, 597 of the prior embodiments. Alternatively, the flange 797 could be otherwise formed without departing from the disclosure.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In general, the blanks may be constructed from paperboard having a caliper so that it is heavier and more rigid than ordinary paper. The blank can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A container for holding one or more products, the container comprising:
at least a bottom wall and a sidewall extending along an interior of the container;
a flange extending outwardly from the sidewall; and
a storage feature extending from the flange and spaced apart from the sidewall, the storage feature being for at least partially holding one or more items.

2. The container of claim 1, wherein the storage feature is foldably connected to the flange along a fold line.

3. The container of claim 2, wherein the storage feature comprises a storage panel foldably connected to the flange along the fold line and a strap defined in the storage panel, the storage feature being for engaging the one or more items between at least a portion of the storage panel and the strap.

4. The container of claim 3, wherein the strap is at least partially defined between two or more slots extending in the storage panel, the two or more slots being for receiving at least a portion of the one or more items engaged with the storage feature.

5. The container of claim 3, wherein the storage feature further comprises a plurality of longitudinal fold lines extending in the storage panel for facilitating bending of the storage panel.

6. The container of claim 2, wherein the storage feature is in the form of a pocket comprising a storage top panel and a storage bottom panel extending along a storage interior.

7. The container of claim 6, wherein the fold line is a first fold line, the storage top panel is foldably connected to the flange along the first fold line, and the storage bottom panel is foldably connected to the storage top panel along a second fold line.

8. The container of claim 6, wherein the storage bottom panel is foldably connected to the storage top panel, wherein the pocket further comprises an attachment flap foldably connected to the storage bottom panel, and wherein the attachment flap is in an overlapping relationship with the storage top panel.

9. The container of claim 1, wherein the storage feature comprises a storage top panel and a storage bottom panel extending at least partially around a storage interior, and wherein the storage feature comprises one or more end flaps at least partially closing an end of the storage feature.

10. The container of claim 9, wherein the one or more end flaps comprise at least a top end flap foldably connected to the storage top panel and a bottom end flap foldably connected to the storage bottom panel, and wherein the top end flap and the bottom end flap are at least partially overlapped.

11. The container of claim 10, wherein the top end flap is foldably connected to the storage top panel along a first V-shaped fold line and the bottom end flap is foldably connected to the storage bottom panel along a second V-shaped fold line, and wherein the first V-shaped fold line and the second V-shaped fold line facilitate holding the top end flap and the bottom end flap in a closed position at the end of the storage feature.

12. The container of claim 10, wherein the storage feature further comprises a first side panel and a second side panel, each extending from the storage top panel to the storage bottom panel, and wherein the one or more end flaps further comprise a side end flap foldably connected to the first side panel and in an at least partially overlapping relationship with the top end flap and the bottom end flap.

13. The container of claim 1, wherein the storage feature is in the form of a carton, the carton comprising a storage top panel, a storage side panel foldably connected to the storage top panel, and a storage bottom panel foldably connected to the storage side panel.

14. The container of claim 13, wherein the storage side panel is a first storage side panel, wherein the storage feature further comprises a second storage side panel foldably connected to the storage bottom panel and an attachment flap foldably connected to the second storage side panel, and wherein the attachment flap is secured at least partially in face-to-face contact with the storage top panel.

15. A blank for forming a container for holding one or more products, the blank comprising:
a top panel for at least partially forming a flange when the container is formed from the blank;
a plurality of side flaps foldably connected to the top panel along an opening in the top panel, the plurality of side flaps being for at least partially forming a sidewall of the container formed from the blank, the flange extending outwardly from the sidewall when the container is formed from the blank; and
a storage feature extending from the top panel and spaced apart from the opening in the top panel, the storage feature being for at least partially holding one or more items when the container is formed from the blank.

16. The blank of claim 15, wherein the storage feature is foldably connected to the flange along a fold line.

17. The blank of claim 16, wherein the storage feature comprises a storage panel foldably connected to the flange along the fold line and a strap defined in the storage panel, the storage feature being for engaging the one or more items between at least a portion of the storage panel and the strap.

18. The blank of claim 17, wherein the strap is at least partially defined between two or more slots extending in the storage panel, the two or more slots being for receiving at least a portion of the one or more items engaged with the storage feature.

19. The blank of claim 17, wherein the storage feature further comprises a plurality of longitudinal fold lines extending in the storage panel for facilitating bending of the storage panel.

20. The blank of claim 16, wherein the storage feature comprises a storage top panel and a storage bottom panel for forming a pocket when the container is formed from the blank.

21. The blank of claim 20, wherein the fold line is a first fold line, the storage top panel is foldably connected to the top panel along the first fold line, and the storage bottom panel is foldably connected to the storage top panel along a second fold line.

22. The blank of claim 15, wherein the storage feature comprises a storage top panel and a storage bottom panel, and wherein the storage feature comprises at least a top end flap foldably connected to the storage top panel and a bottom end flap foldably connected to the storage bottom panel for at least partially closing an end of the storage feature when the container is formed from the blank.

23. The blank of claim 22, wherein the top end flap is foldably connected to the storage top panel along a first V-shaped fold line and the bottom end flap is foldably connected to the storage bottom panel along a second V-shaped fold line, and wherein the first V-shaped fold line and the second V-shaped fold line facilitate holding the top end flap and the bottom end flap in a closed position at the end of the storage feature when the carton is formed from the blank.

24. The blank of claim 22, wherein the storage feature further comprises a first side panel, a second side panel, and a side end flap foldably connected to the first side panel.

25. The blank of claim 15, wherein the storage feature comprises a storage top panel, a storage side panel foldably connected to the storage top panel, and a storage bottom panel foldably connected to the storage side panel for at least partially forming a carton when the container is formed from the blank.

26. The blank of claim 25, wherein the storage side panel is a first storage side panel, wherein the storage feature further comprises a second storage side panel foldably connected to the storage bottom panel and an attachment flap foldably connected to the second storage side panel, and wherein the attachment flap is for being secured at least partially in face-to-face contact with the storage top panel when the carton is formed from the blank.

27. A method of forming a container, the method comprising;
obtaining a blank comprising a top panel, a plurality of side flaps foldably connected to the top panel along an opening in the top panel, and a storage feature extending from the top panel and spaced apart from the opening in the top panel; and
forming a sidewall at least by folding the plurality of side flaps downwardly with respect to the top panel, the top panel at least partially forming a flange extending outwardly from the sidewall;
wherein the storage feature is for at least partially holding one or more items.

28. The method of claim 27, wherein the storage feature comprises a storage panel foldably connected to the flange and a strap defined between two or more slots extending in the storage panel, the storage feature being for engaging the one or more items between at least a portion of the storage panel and the strap.

29. The method of claim 27, wherein the storage feature comprises a storage top panel foldably connected to the top panel and a storage bottom panel foldably connected to the storage top panel, and wherein the method further comprises forming a pocket by positioning the storage top panel and the storage bottom panel at least partially around a storage interior.

30. The method of claim 27, wherein the storage feature comprises a storage top panel, a storage bottom panel, a top end flap foldably connected to the storage top panel, and a bottom end flap foldably connected to the storage bottom panel, and wherein the method further comprises positioning the storage top panel and the storage bottom panel to extend at least partially around a storage interior and folding the top end flap and the bottom end flap to at least partially close an end of the storage feature.

31. The method of claim 30, wherein the top end flap is foldably connected to the storage top panel along a first V-shaped fold line and the bottom end flap is foldably connected to the storage bottom panel along a second V-shaped fold line, and wherein the first V-shaped fold line and the second V-shaped fold line facilitate holding the top end flap and the bottom end flap in a closed position at the end of the storage feature.

32. The method of claim 30, wherein the storage feature further comprises a first side panel, a second side panel, and a side end flap foldably connected to the first side panel, and wherein the method further comprises folding the side end flap to overlap the top end flap and the bottom end flap.

33. The method of claim 27, wherein the storage feature comprises a storage top panel, a storage side panel foldably connected to the storage top panel, and a storage bottom panel foldably connected to the storage side panel, and wherein the method further comprises forming a carton by positioning the storage top panel, the storage side panel, and the storage bottom panel at least partially around a storage interior of the carton.

34. A container for holding one or more products, the container comprising:
a flange;
a first sidewall extending along at least a portion of the flange, the first sidewall extending at least partially around a first interior space of the container;
a second sidewall extending along at least a portion of the flange, the second sidewall extending at least partially around a second interior space of the container; and
a fold line extending in the flange between the first interior space and the second interior space, the fold line being for folding the container at the flange to pivot the second sidewall with respect to the first sidewall.

35. The container of claim 34, further comprising a storage feature extending from the flange.

36. The container of claim 34, wherein the fold line is V-shaped with two oblique segments extending from a vertex.

37. The container of claim 36, wherein the second sidewall at least partially defines a spout, the spout being aligned with the vertex of the fold line.

38. The container of claim 34, wherein the second sidewall comprises two side panels extending at an oblique angle with respect to one another to at least partially define a pouring spout for pouring at least a portion of one or more products from the second interior space into the first interior space.

39. The container of claim 34, further comprising a crown component comprising a top panel at least partially defining the flange, a plurality of first side flaps at least partially defining the first sidewall, and a plurality of second side flaps at least partially defining the second sidewall, wherein the fold line extends in the top panel of the crown component.

40. The container of claim 39, further comprising at least a first bottom component and a second bottom component, wherein the first bottom component comprises a plurality of first side panels at least partially defining the first sidewall and the second bottom component comprises a plurality of second side panels at least partially defining the second sidewall.

41. The container of claim 40, wherein the first bottom component further comprises a plurality of first flange portions extending from respective first side panels of the plurality of first side panels and the second bottom component further comprises a plurality of second flange portions extending from respective second side panels of the plurality of second side panels, and wherein the plurality of first flange portions and the plurality of second flange portions are at least partially overlapped by the top panel of the crown component so that the plurality of first flange portions and the plurality of second flange portions cooperate with the top panel to at least partially form the flange.

42. The container of claim 41, wherein one or more first flange portions are arranged adjacent one or more second flange portions along a line that is aligned with the fold line in the top panel.

43. The container of claim 40, wherein the first bottom component comprises a first bottom panel extending along at least a portion of the first interior space, and the second bottom component comprises a second bottom panel extending along at least a portion of the second interior space.

44. In combination, a crown blank, a first bottom blank, and a second bottom blank for at least partially forming a container for holding one or more products,
the crown blank comprising at least a top panel for at least partially forming a flange of the container formed from the crown blank, the first bottom blank, and the second bottom blank;
the first bottom blank comprising a plurality of first side panels for at least partially forming a first sidewall extending along at least a portion of the flange when the container is formed from the crown blank, the first bottom blank, and the second bottom blank;
the second bottom blank comprising a plurality of second side panels for at least partially forming a second sidewall extending along at least a portion of the flange when the container is formed from the crown blank, the first bottom blank, and the second bottom blank; and
a fold line extending in the top panel between the first sidewall and the sidewall when the container is formed from the crown blank, the first bottom blank, and the second bottom blank.

45. The combination of claim 44, further comprising a storage feature extending from the top panel of the crown blank.

46. The combination of claim 44, wherein the fold line is V-shaped with two oblique segments extending from a vertex, and wherein at least two second side panels of the plurality of second side panels are configured for at least partially defining a spout in the second sidewall when the container is formed from the crown blank, the first bottom blank, and the second bottom blank, the spout being aligned with the vertex of the fold line when the container is formed from the crown blank, the first bottom blank, and the second bottom blank.

47. The combination of claim 44, wherein at least two second side panels of the plurality of second side panels are for being positioned to extend at an oblique angle with respect to one another to at least partially define a pouring spout when the container is formed from the crown blank, the first bottom blank, and the second bottom blank.

48. The combination of claim 44, wherein the first bottom blank further comprises a plurality of first flange portions extending from respective first side panels of the plurality of first side panels and the second bottom blank further comprises a plurality of second flange portions extending from respective second side panels of the plurality of second side panels, and wherein the plurality of first flange portions and the plurality of second flange portions are for being at least partially overlapped by the top panel of the crown component so that the plurality of first flange portions and the plurality of second flange portions cooperate with the top panel to at least partially form the flange when the container is formed from the crown blank, the first bottom blank, and the second bottom blank.

49. The combination of claim 44, wherein the first bottom blank comprises a first bottom panel and the second bottom blank comprises a second bottom panel, and wherein the first side panels of the plurality of first side panels are respectively foldably connected to the first bottom panel and the second side panels of the plurality of second side panels are respectively foldably connected to the second bottom panel.

50. A method of forming a container, the method comprising:
obtaining crown blank comprising at least a top panel and a fold line extending in the top panel, a first bottom blank comprising a plurality of first side panels, and a second bottom blank comprising a plurality of second side panels;
forming a first bottom component by folding the plurality of first side panels of the first bottom blank to at least partially form a first sidewall extending along at least a portion of a first interior space of the container;
forming a second bottom component by folding the plurality of second side panels of the second bottom blank to at least partially form a second sidewall extending along at least a portion of a second interior space of the container;
arranging the crown blank relative to the first bottom component and the second bottom component to at least partially form a flange comprising the top panel, the first sidewall and the second sidewall extending along respective portions of the flange, wherein the fold line extends in the top panel between the first interior space and the second interior space.

51. The method of claim 50, further comprising a storage feature extending from the top panel of the crown blank.

52. The method of claim 50, wherein the folding the plurality of second side panels comprises positioning at least two second side panels of the plurality of second side panels to extend at an oblique angle with respect to one another to at least partially define a spout in the second sidewall.

53. The method of claim 50, wherein the first bottom blank further comprises a plurality of first flange portions extending from respective first side panels of the plurality of first side panels and the second bottom blank further comprises a plurality of second flange portions extending from respective second side panels of the plurality of second side panels, and wherein the arranging the crown blank comprises at least partially overlapping the plurality of first flange portions and the plurality of second flange portions with the top panel of the crown blank, the plurality of second flange portions cooperating with the top panel to at least partially form the flange.

54. The method of claim 50, wherein the first bottom blank comprises a first bottom panel and the second bottom blank comprises a second bottom panel, and wherein the forming the first bottom component comprises folding the plurality of first side panels upwardly with respect to the first bottom panel and the forming the second bottom component comprises folding the plurality of second side panels upwardly with respect to the second bottom panel.
